(19) United States
(12) Patent Application Publication
(10) Pub. No.: US 2005/0020781 A1
(43) Pub. Date: Jan. 27, 2005

(54) Resin composition containing rubber component, and film and electronic part using the same

(76) Inventors: Masatoshi Sugimasa, Hitachi (JP); Akira Nagai, Hitachi (JP); Shinji Yamada, Tsukuba (JP); Satoru Amou, Hirachi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/785,978

(22) Filed: Feb. 26, 2004

(30) Foreign Application Priority Data
Jul. 23, 2003 (JP) 2003-200182

(51) Int. Cl. C08F 10/00

(52) U.S. Cl. 525/333.7

(57) ABSTRACT

There is provided a resin composition suitable for insulating materials for use in electronic parts for handling high frequency signals, low in dielectric constant and low in dielectric dissipation factor, capable of forming thin film by low temperature curing, excellent in the adhesiveness to conductive foil and excellent in flexibility; a cured product derived from the composition; and a film substrate and an electronic part using the composition.
A resin composition, low in dielectric dissipation factor, comprising: a crosslinking component having a weight averaged molecular weight of 1,000 or less and a plurality of styrene groups represented by the following general formula: 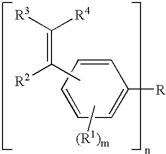
wherein R represents a hydrocarbon moiety; each R¹, which may be the same or different, represents a hydrogen atom or a C₁₋₂₀ hydrocarbon group; R², R³ and R⁴, which may be the same or different, represent a hydrogen atom or a C₁₋₆ alkyl group; and m is an integer of 1 to 4, and n is an integer of 2 or more; and a rubber component having a weight averaged molecular weight of 5,000 or more and styrene units; a cured product; and a film substrate and an electronic part using the composition.

### BACKGROUND OF THE INVENTION

1. Field of the Invention

The present invention relates to a resin composition containing a rubber component suitable for insulating materials for use in electronic parts for handling high frequency signals, and a film and an electronic part using the composition.

2. Background Art

The greater sophistication of devices and the diversification of media in these years are accompanied by accelerative increase of communicated and transmitted volumes of information. Information communication becomes faster and higher in frequency such that the signal bands of information communication devices including radio communication devices and cellular phones and the clock frequencies of computers and peripheral devices thereof have come to get to the GHz band. The “skin effect” signifying the effect in which the current flows on the surface of a conductor becomes remarkable in the high frequency regions, so that the greater is the surface roughness, the greater is the transmission loss. Accordingly, for the purpose of enhancing the processing speed, it is required to reduce the surface roughness of the conductor layer.

On the other hand, however, the surface roughness of a conductive layer leads to an effect to enhance adhesiveness between the conductive layer and an insulating resin to form a substrate, and accordingly a conductive layer with low roughness cannot bring sufficient adhesiveness and causes a problem that deficiencies including wiring disconnection and the like tend to occur.

Copper foil is mainly used as a conductive layer for a circuit board; methods so far proposed for the purpose of improving adhesiveness between copper foil and resin include a method in which copper foil and a resin tape are adhered together with the aid of an adhesive and a method in which a copper alloy foil is used. For example, JP Patent Publication (Unexamined Application) No. 6-5660 (1994) discloses a method in which copper foil and a resin tape are adhered together with the aid of an adhesive added with vinylsilane and an organic peroxide, while JP Patent Publication (Unexamined Application) No. 2002-226928 discloses a method in which adhesiveness is improved by using a copper alloy added with a small amount of an additive element.

[Patent Document 1]

JP Patent Publication (Unexamined Application) No. 6-5660 (1994)

[Patent Document 2]

JP Patent Publication (Unexamined Application) No. 2002-226928

The use of an adhesive and the modification of the composition of the conductive layer itself as described above for the purpose of improving the adhesion strength between the conductive layer and the resin substrate leads to an increase in the number of the processing steps, resulting in a disadvantage in view of the cost. Additionally, it is conceivable that the presence of an adhesive possibly affect adversely the dielectric properties.

An object of the present invention is to provide a resin composition excellent in adhesiveness to a conductive by adding a rubber component to the resin forming a substrate, without using adhesives or without applying treatments such as modification of the conductive layer.

### SUMMARY OF THE INVENTION

Now, the resin composition containing a rubber component of the present invention will be described blow.

The resin composition containing a rubber component of the present invention is a highly adhesive resin composition characterized in that the resin composition comprises a crosslinking component having a weight averaged molecular weight of 1,000 or less represented by the following general formula: 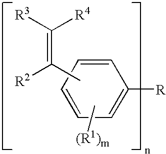
wherein R represents a hydrocarbon moiety; each R¹, which may be the same or different, represents a hydrogen atom or a C₁₋₂₀ hydrocarbon group; R², R³ and R⁴, which may be the same or different, represent a hydrogen atom or a C₁₋₆ alkyl group; and m is an integer of 1 to 4, and n is an integer of 2 or more; and
a rubber component having a weight averaged molecular weight of 5,000 or more and styrene units.

Because the multi-functional styrene compound, which is a crosslinking component, contains no polar groups, so that an extremely low dielectric constant and an extremely low dielectric dissipation factor are obtained. Examples of the preferable styrene compounds include 1,2-bis(p-vinylphenyl)ethane, 1,2-bis(m-vinylphenyl)ethane, 1-(p-vinylphenyl)-2-(m-vinylphenyl)ethane, 1,4-bis(p-vinylphenylethyl)benzene, 1,4-bis(m-vinylphneylethyl)benzene, 1,3-bis(p-vinylphenylethyl)benzene, 1,3-bis(m-vinylphenylethyl)benzene, bisvinylphenylmethane, 1,6-(bisvinylphenyl)hexane, and divinylbenzene polymers (oligomers) having vinyl groups on the side chains. The weight averaged molecular weight (Gas Permeation Chromatography (GPC), relative to polystyrene standards) of the present crosslinking component is 1,000 or less.

In the present invention, by blending a rubber component containing styrene units having a good compatibility with the crosslinking component and a crosslinking component having a low dielectric dissipation factor, the cured product obtained from the resin composition is given the film formability, flexibility and adhesiveness. This permits producing a variety of circuit boards and TAB tapes that hardly undergo exfoliation between the insulating layer and conductive layer, namely, is highly reliable. Examples of the rubber component include styrene-butadiene, styrene-isoprene, styrene-ethylene-butylene-styrene, styrene-ethylene-propylene-styrene, styrene-maleic acid-butadiene, acrylonitrile-butadiene-styrene, and acrylonitrile-ethylene-propylene-styrene rubbers. The molecular weight of the rubber component is 5,000 or more, and more preferably 5,000 to 100,000. With a small molecular weight, the film formability, flexibility and adhesiveness sometimes become insufficient. On the other hand, with a too large molecular weight, when the resin composition is made to turn into a varnish, the varnish sometimes exhibits a high viscosity, so that mixing, stirring, film formation and impregnation possibly become difficult. The type of the rubber component is not particularly limited, and accordingly two or more components can be used in mixture.

Additionally, the use of a rubber component in which the proportion of carbon atoms and hydrogen atoms is 99% or more in relation to all the chemical elements constituting the rubber component permits further lowering of dielectric dissipation factor. Among the preferable examples is styrene-butadiene rubber. Styrene-butadiene rubber has a high compatibility with the multi-functional styrene compound, the crosslinking component, and has a low dielectric constant. Accordingly, without degrading the dielectric characteristics of the crosslinking component low in dielectric dissipation factor, flexibility and adhesiveness can be provided to the resin composition. As for the proportion of the styrene moiety and the proportion of the butadiene moiety, both in relation to one molecule, the proportion of the styrene moiety is preferably 30 to 80 wt %. When the proportion of the styrene moiety is too small, the compatibility with the multi-functional styrene compound, the crosslinking component, is lowered, so that the film formability, strength, and flexibility of the resin composition become insufficient. Additionally, when the proportion of the styrene moiety is too large, the flexibility and adhesiveness of the resin composition are lowered, and thus the peel strength is reduced.

Furthermore, in the present invention, by making a high molecular weight polymer be contained, the resin composition can be provided with improved mechanical properties. The molecular weight of the high molecular weight polymer is preferably 5,000 to 100,000. When the molecular weight is too small, the mechanical properties sometimes become insufficient, while when too large, the viscosity of the varnish becomes high. Examples of the high molecular weight polymer include polyphenylene oxide, polysulfone, polyetherimide and polyolefin having alicyclic structure, which may have substituents. Among these, preferable are polyphenylene oxide and cyclic polyolefin from the viewpoint of the strength and the low dielectric dissipation factor. The high molecular weight polymers may also be used in combinations.

Additionally, the mechanical properties of the resin composition can also be improved by incorporating, as a second crosslinking component, general-purpose curing resins having polar groups such as phenol resin, epoxy resin, vinylbenzylether resin, cyanate resin and maleimide resin into the highly adhesive resin composition.

In the present invention, a curable film can be easily produced by dissolving the highly adhesive resin composition in an organic solvent, and applying the varnish onto or impregnated into organic or inorganic cloth, unwoven cloth, and film, and drying thereafter. The drying conditions depend on the composition of the highly adhesive resin composition and the type of the solvent used in varnish preparation; for example, when toluene is used as the organic solvent, the drying conditions are preferably such that the drying is performed at 80 to 100° C. for about 30 to 90 minutes. The substrate for film is not particularly limited, and various types of glass cloth, unwoven glass cloth, unwoven aramid, unwoven liquid crystalline polymer cloth, liquid crystalline polymer film, porous polytetrafluoroethylene (PTFE) and the like can be used.

Any organic solvent can be used in turning the highly adhesive resin composition into a varnish, as far as the solvent can dissolve the crosslinking component(s) and the high molecular weight polymer. Examples of the solvent include ketones such as acetone and methyl ethyl ketone; aromatic hydrocarbons such as toluene and xylene; amides such as N,N-dimethylformamide and N,N-dimethylacetamide; and ethers such as diethyl ether, ethylene glycol monomethyl ether, propylene glycol monomethyl ether, tetrahydrofuran and dioxane. Two or more organic solvents may be mixed together.

The above described curable film can be used as a cured film by applying the hot press processing. The curing conditions for the cured film formation are preferably such that, when the press processing is applied, the curing processing is conducted at 150 to 180° C. for an hour to 3 hours with a press pressure of 1 to 5 MPa.

In the present invention, a curable film having a conductive layer on either or both surfaces can be produced by laminating conductive foil such as electrolytic copper foil onto cloth, unwoven cloth, or film which has been applied or impregnated with the resin composition and by drying subsequently. Additionally, by applying the hot press processing, a cured film having a conductive layer or conductive layers can also be obtained. By applying wiring processing, on the basis of the conventional etching method, to a curable film or a cured film having a conductive layer on either or both surfaces, a variety of circuit boards and TAB tapes can be produced which are low in transmission loss. Furthermore, a multilayer circuit board can be obtained by laminating a plurality of sheets of cured film, after having undergone wiring processing, with interposing sheets of the above described curable film, and by applying the hot press processing subsequently.

The highly adhesive resin composition of the present invention can be cured merely by heating, namely, without adding a curing catalyst; however, for the purpose of improving curing efficiency, a curing catalyst capable of polymerizing styrene groups can be added. The amount of addition is not limited, but thereof is preferably 0.0005 to 10 parts by weight in relation to 100 total parts by weight of the above described crosslinking component and high molecular weight polymer or the second crosslinking component, on the basis of the apprehension that the residue of the curing catalyst may adversely affect the dielectric properties. The addition of the curing catalyst within the above described range improves the polymerization of the styrene groups, and a cured product tough at low temperatures can be obtained. Examples of the curing catalyst that produces, with the aid of heat or light, a cationic active species or a radical active species capable of initiating the polymerization of the styrene groups are described below. Examples of the cationic polymerization initiator include diaryliodonium salts, triarylsulphonium salts and aliphatic sulphonium salts having BF₄, PF₆, AsF₆, and SbF₆ as counter anions; examples of commercially available initiators concerned include SP-70, SP-172 and CP-66 manufactured by Asahi Denka Co., Ltd., CI-2855 and CI-2823 manufactured by Nippon Soda Co., Ltd., and SI-100L and SI-150L manufactured by Sanshin Chemical Industry Co., Ltd. Examples of the radical polymerization initiator include benzoin based compounds such as benzoin and benzoin methyl; acetophenone based compounds such as acetophenone and 2,2-dimethoxy-2-phenylacetophenone; thioxanthone based compounds such as thioxanthone and 2,4-diethylthioxanthone; bisazide compounds such as 4,4′-diazidechalcone, 2,6-bis(4′-azidebenzal)cyclohexanone and 4,4′-diazidebenzophenone; azo compounds such as azobisisobutylnitrile, 2,2-azobispropane, m,m′-azoxystyrene and hydrazone; and organic peroxides such as 2,5-dimethyl-2,5-di(t-butylperoxy)hexane, 2,5-dimethyl-2,5-di(t-butylperoxy)hexyne-3, and dicumylperoxide. It is particularly preferable to add such organic peroxides or bisazide compounds capable of causing hydrogen abstraction reaction in compounds having no functional groups and forming the cross-linkage between the crosslinking component and the high molecular weight polymer.

This specification includes part or all of the contents as disclosed in the specification of Japanese Patent Application No. 2003-200182, which is base of the priority claim of the present application.

### BRIEF DESCRIPTION OF THE DRAWINGS

FIG. 1 is a schematic diagram illustrating the processes for the production of a film-type circuit board; and

FIG. 2 is a schematic diagram illustrating the processes for the production of a flexible multilayer circuit board.

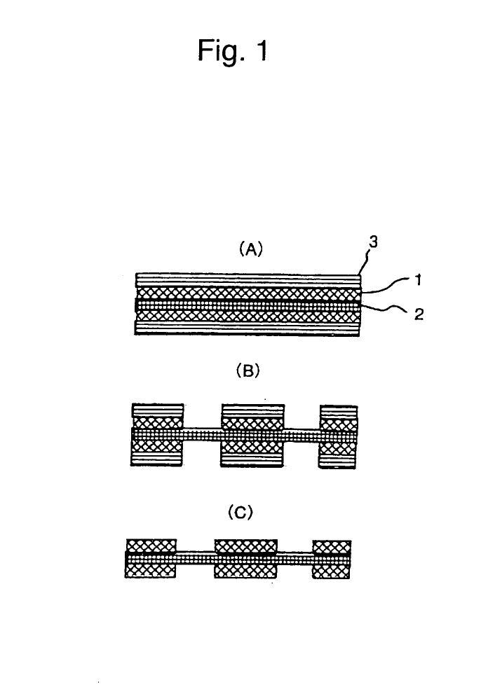

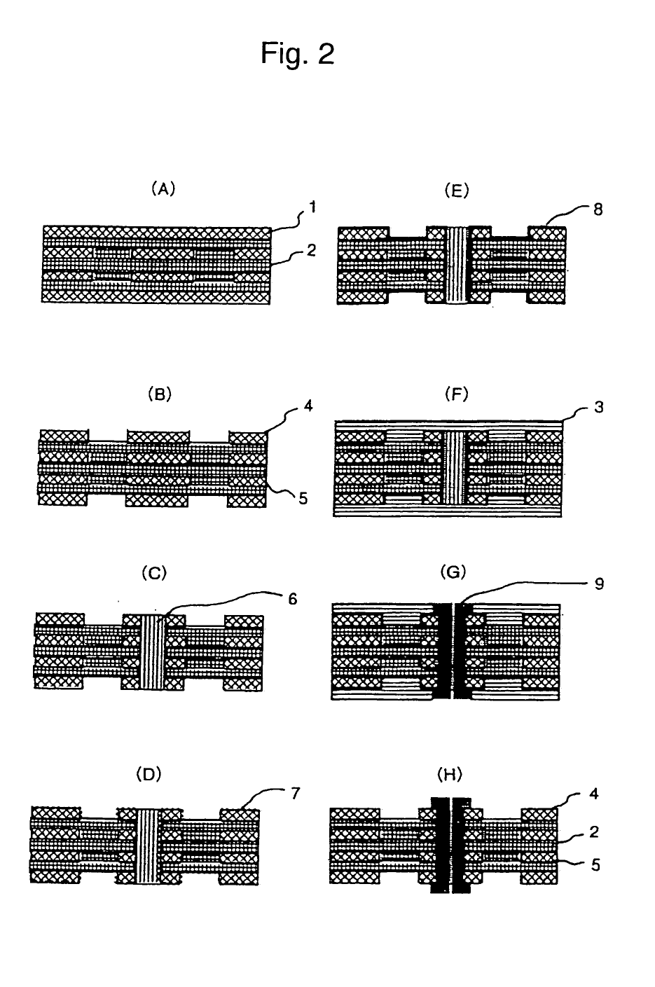

Each number in FIG. 1 and 2 means the follwing.

1—electrolytic copper foil

2—cured film

3—photoresist

4—exterior layer wiring

5—interior layer wiring

6—through hole

7—plating catalyst

8—seed film

9—plated copper

### DETAILED DESCRIPTION OF THE PREFERRED EMBODIMENTS

The present inventors investigated the improvement of the adhesiveness between a resin, low in dielectric dissipation factor containing a multi-functional styrene compound excellent in dielectric properties, and a copper foil low in surface roughness (a low profile copper foil). Consequently, it has been revealed that dispersion of a rubber component in the resin low in dielectric dissipation factor makes it possible to drastically improve the adhesivity between the resin and the low profile copper foil by 0.8 kN/m or more, without degrading the excellent dielectric characteristics of the resin low in dielectric dissipation factor such that the dielectric constant is 3.0 or smaller and the dielectric dissipation factor is 0.003 or less.

Now, the present invention will be described specifically below with reference to Examples and Comparative Examples. It should be noted that “parts” in the following description signifies “parts by weight,” unless otherwise specified.

Table 1 shows the compositions and properties involved in Examples and Comparative Examples. The names and the synthesis methods of the reagents used in Examples and Comparative Examples, the preparation method of varnishes and the evaluation method of the products are described below.

(1) Synthesis of 1,2-bis(vinylphenyl)ethane (BVPE)

1,2-Bis(vinylphenyl)ethane (BVPE) was synthesized according to the known method described below. In a 500 ml three-neck flask, 5.36 g (220 mmol) of granular magnesium for the Grignard reaction (manufactured by Kanto Kagaku Co., Ltd.) was placed, and a dropping funnel, a nitrogen introducing tube and a septum cap were fixed to the flask. While stirring the magnesium grains with a stirrer under a flow of nitrogen, the whole system was subjected to thermal dehydration with a drier. Dried tetrahydrofuran was taken in a 300 ml syringe and injected into the flask through a septum cap. The solution thus obtained was cooled to −5° C., and then 30.5 g (200 mmol) vinylbenzyl chloride (VBC, manufactured by Tokyo Kasei Kogyo Co., Ltd.) was dropped into the flask over a period of about 4 hours. After completion of the dropping, the solution was continuously stirred at 0° C. and for 20 hours. After completion of the reaction, the reaction solution was filtered to remove the residual magnesium, and concentrated with an evaporator. The concentrated solution was diluted with hexane, washed once with 3.6% aqueous hydrochloric acid solution, three times with pure water, and then dehydrated with magnesium sulfate. The dehydrated solution was purified by passing the solution through a short column of silica gel (Wako gel C300 manufactured by Wako Pure Chemical Industries, Ltd.)/hexane, and dried under vacuum to yield BVPE. The BVPE thus obtained was a mixture composed of the m-m isomer (liquid), m-p isomer (liquid) and p-p isomer (crystal) and the yield was 90%; by ¹H-NMR analysis was conducted to determine the molecular structure and the obtained values are in good agreement with the literature values (6H-vinyl:α-2H, 6.7, β-4H, 5.7, 5.2; 8H-aromatic: 7.1 to 7.35; 4H-methylene: 2.9). The BVPE thus obtained was used as a crosslinking component.

(2) Other Constituent Components

As the other constituent components, the following materials were used. Rubber component:
ABS: Poly(acrylonitrile-co-butadiene-co-styrene) manufactured by Aldrich, Co., Ltd.
SB: Polystyrene-block-polybutadiene manufactured by Aldrich, Co., Ltd. High molecular weight polymer:
PPE: poly-(2,6-dimethyl-1,4-phenylene oxide) manufactured by Aldrich, Co., Ltd. General-purpose curing resin:
Ep828: Bisphenol A type epoxy resin (EPIKOTE®, Ep828) manufactured by Yuka-Shell Epoxy Co., Ltd.
   Curing Catalyst:
25B: 2,5-Dimethyl-2,5-bis(t-butylperoxy)hexyne-3 (PERHEXYNE™ 25B) manufactured by NOF Corp.
CP66: Thermal acid generator manufactured by Asahi Denka Co., Ltd.
   Organic Unwoven Cloth:
Unwoven liquid crystalline polymer cloth MBBK40 manufactured by Kuraray Co., Ltd.

(3) Preparation Method of Varnish

A varnish of the resin composition was prepared by dissolving the predetermined amounts of a high molecular weight polymer, a crosslinking component, a rubber component and a curing catalyst in chloroform.

(4) Production of Resin Board

The above described varnish was applied onto a PET film and dried, and the varnish film formed was then peeled off; the peeled varnish film was placed in spacers made of PTFE, and heated and pressurized through a copper foil, a polyimide film and an end plate under vacuum, to produce a resin board with copper foil. The heating conditions were such that a multistep heating was conducted successively with 120° C./30 minutes, 150° C./30 minutes, and 180° C./100 minutes, and the press pressure of 1.5 MPa. The film size was such that 70×70×1 mm.

(5) Production of Cured Film

The above described varnish was applied onto the unwoven cloth and dried; then the resin containing unwoven cloth, a copper foil, a polyimide film and an end plate were superposed, heated and pressurized under vacuum to produce a composite film with copper foil. The heating conditions were such that a multistep heating was conducted successively with 120° C./30 minutes, 150° C./30 minutes, and 180° C./100 minutes, and the press pressure 1.5 MPa. The film size was such that 150×70×0.005 to 0.01 mm.

(6) Peel Strength

Samples for peel strength measurement were produced by forming a resin layer of each resin composition on a low profile electrolytic copper foil (thickness: 18 μm; surface roughness: 2.6 μm) under the same conditions as applied in the production method of a cured composite film. The thickness of a cured composite film was made to be 0.005 to 0.01 mm and the size thereof 70×150 mm. The low profile electrolytic copper foil on the composite film was cut to a strip of 10 mm in width, and the peel strength of the strip was measured.

(7) Measurement of Dielectric Constant and Dielectric Dissipation Factor

The dielectric constants and dielectric dissipation factors were measured as the values at 10 GHz by means of the cavity resonator method (Network Analyzer 8722ES manufactured by Agilent Technologies Corp., Cavity Resonator manufactured by Kanto Electronics Application and Development Inc.)

(8) Measurement of Tensile Strength and Elongation

Tensile strengths and elongations were measured on columnar samples of 1 mm in thickness, 1 mm in width and 70 mm in length, by means of a tensile tester (Autograph AGS-100 manufactured by Shimadzu Corp.) under the conditions that the temperature was room temperature, the distance between the supporting points was 20 mm, and the tensile rate was 10 mm/min.

### COMPARATIVE EXAMPLE 1

Comparative Example 1 is an example of a resin composition comprising BVPE as the crosslinking component and 1 part of curing catalyst 25B in relation to the weight of BVPE. The cured product obtained from this composition was produced as a resin board with copper foil as follows: a superposed set of a spacer made of PTFE and a low profile copper foil were sandwiched between a pair of glass plates to form a laminate, the resin composition was injected without using any solvent into the clearances found in the laminate, and the laminate was sealed and heated for curing to yield the resin board with copper foil. The resin board thus obtained was poor both in flexibility and in adhesiveness, exhibiting a low peel strength of 0.23 kN/m.

### EXAMPLE 1

Example 1 is an example of a resin composition comprising BVPE as the crosslinking component and ABS as the rubber component, both in 50 parts by weight, and 1 part of the curing catalyst 25B in relation to the total weight of the resin components. The cured product obtained from this composition was produced as a resin board according to the above described method. The peel strength of the resin board thus produced was 1.18 kN/m, which exceeds the value (0.8 kN/m) generally accepted as practically free from problems. Thus, it is possible to impart excellent adhesiveness to a resin board by adding a rubber component to a resin composition.

### EXAMPLE 2

Example 2 is an example of resin composition that comprises SB composed of carbon atoms and hydrogen atoms and containing no polar groups, instead of ABS in Example 1, for the purpose of lowering the dielectric dissipation factor of the cured product to be derived from the resin composition. The cured product of this resin composition was produced as a resin board according to the above described method. The resin board thus produced exhibited a peel strength of 1.21 kN/m, displaying excellent adhesiveness similarly to Example 1. The dielectric constant and dielectric dissipation factor were respectively found to be small, 2.35 and 0.0029. Thus, the addition of a rubber component containing no polar groups is found to be an effective means for imparting sufficient adhesiveness to the resin board while maintaining excellent dielectric properties.

### EXAMPLE 3

Example 3 is an example of a resin composition comprising BVPE as the crosslinking component and PPE as the high molecular weight polymer, both in 50 parts by weight, SB as the rubber component in 25 parts, and 1 part of the curing catalyst 25B in relation to the total weight of the crosslinking component and the high molecular weight polymer. The cured product of this resin composition was produced as a resin board according to the above described method. The addition of the high molecular weight polymer served to improve the mechanical properties of the resin board thus obtained such that the tensile strength thereof exhibited a high value of 79.6 MPa. Additionally, the use of PPE having no polar groups as the high molecular weight polymer served to exhibit a low dielectric constant value of 2.43 and a low dielectric dissipation factor of 0.0021. The peel strength was 1.34 kN/m, displaying excellent adhesiveness similarly to Example 2.

### EXAMPLE 4

Example 4 is an example of a resin composition comprising BVPE as the crosslinking component and bisphenol A epoxy resin Ep828 as the second crosslinking component, both in 50 parts by weight, PSB as the rubber component in 25 parts, and 1 part of the curing catalyst CP66 in relation to the total weight of the crosslinking component and the second crosslinking component. The cured product of this resin composition was produced as a resin board according to the above described method. The tensile strength of the resin board thus produced exhibited a high value of 71.3 MPa. The addition of a curing resin as the second crosslinking component succeeded in imparting mechanical properties comparable to those of the resin board, shown in Example 3, containing an added high molecular weight polymer.

TABLE 1

| Comparative | Example | Example | Example | Example |
|---|---|---|---|---|
| Example 1 | 1 | 2 | 3 | 4 |

Composition
ratio

| | | | | | |
|---|---|---|---|---|---|
| BVPE | 100 | 50 | 50 | 50 | 50 |
| ABS | 0 | 50 | 0 | 0 | 0 |
| SB | 0 | 0 | 50 | 25 | 25 |
| PPE | 0 | 0 | 0 | 50 | 0 |
| Ep828 | 0 | 0 | 0 | 0 | 50 |
| 25B | 1 | 1 | 1 | 1 | 0 |
| CP66 | 0 | 0 | 0 | 0 | 1 |
| Properties | | | | | |
| Dielectric | 2.56 | 2.78 | 2.35 | 2.43 | 2.68 |
| constant | | | | | |
| Dielectric | 0.0017 | 0.023 | 0.0029 | 0.0021 | 0.014 |
| dissipation | | | | | |
| factor | | | | | |
| Peel | 0.23 | 1.18 | 1.21 | 1.34 | 1.33 |
| strength | | | | | |
| (kN/m) | | | | | |
| Tensile | 31.2 | 36.6 | 33.2 | 79.6 | 71.3 |
| strength | | | | | |
| (MPa) | | | | | |

### COMPARATIVE EXAMPLE 2

Comparative Example 2 is an example of a curable film produced as follows: a resin composition comprising BVPE as the crosslinking component and PPE as the high molecular weight polymer, both in 50 parts, and 1 part of the curing catalyst 25B in relation to the total weight of the resin components was applied onto an unwoven liquid crystalline polymer cloth MBBK40 and dried to yield the curable film. The curable film thus produced was brittle and tended to be cracked, involving a problem of difficulty to use.

### EXAMPLE 5

Example 5 is an example of a curable film produced as follows: the resin composition of Example 3, namely, the resin composition comprising BVPE as the crosslinking component and PPE as the high molecular weight polymer, both in 50 parts by weight, SB as the rubber component in 25 parts, and 1 part of the curing catalyst 25B in relation to the total weight of the crosslinking component and the high molecular weight polymer, was applied onto an unwoven liquid crystalline polymer cloth MBBK40 to yield the curable film. The curable film was produced according to the same method as that in Comparative Example 2. The curable film thus produced was high in flexibility and adhesiveness, and easy to use. By superposing the curable film and a copper foil with each other and by thereafter applying press processing or lamination processing, a copper clad laminate high in reliability can be easily obtained.

### EXAMPLE 6

A curable film having a conductive copper foil on one surface thereof can be obtained by applying the resin composition of Example 3 onto the unwoven cloth MBBK40, adhering thereof on the rough surface of a low profile copper foil and drying the adhesion product. The adhesiveness between the curable film and a conductive copper foil was satisfactory. The curable film is easy to use, and press processing under vacuum of the superposed curable films can easily produce a multilayer laminate. By adjusting the number of ply, the lamination number of the multilayer laminate can be optionally controlled.

### COMPARATIVE EXAMPLE 3

The curable film produced in Comparative Example 2 was sandwiched between 2 sheets of the low profile copper foil, and subjected to press processing under vacuum to produce a double-sided copper clad cured film, and a circuit was formed on the surface of the film. FIG. 1 illustrates an example of a set of processes for the wiring formation. (A) A sheet of a photoresist (HS425 manufactured by Hitachi Chemical Co., Ltd.) was laminated on the double-sided copper clad cured film; a test pattern was exposed onto the photoresist and the photoresist was developed using a 1% sodium carbonate solution. (B) By use of an etching solution containing sulfuric acid in 5% and hydrogen peroxide in 5%, the unexposed portions of the copper foil was removed by etching, to form conductive wirings on both surfaces. (C) The photoresist on the conductive wirings were removed by use of a 3% sodium hydroxide solution to produce a film-like circuit board having conductive wirings on both surfaces thereof. The adhesiveness between the cured film, as an insulating layer, and the copper wirings was weak; when the wiring width was 70 μm or less, wiring exfoliation and the plating solution soakage between the copper foil and the cured film were observed.

### EXAMPLE 7

A cured film having circuit layers on both surfaces was obtained by using the curable film produced in Example 5 according to the same method as adopted in Comparative Example 3. The cured film as the insulating layer was excellent in adhesiveness and flexibility, and satisfactory in the adhesiveness with the copper wiring. Even when the wiring width was reduced to 10 μm, exfoliation, breaking or the like of the wiring was not observed. By using cured films each having wiring on both surfaces of Example 7, fine pitching for the wiring width and wiring intervals can be promoted, thus permitting producing a variety of circuit boards and TAB tapes excellent in high frequency characteristics and high in reliability.

### EXAMPLE 8

Now, description will be made below on the production examples of the multilayer circuit boards by use of the curable film of Example 6 having a conductive copper foil on one surface thereof and the cured film of Example 7 having conductive wiring layers on both surfaces thereof. FIG. 2 illustrates an example of a set of processes for the wiring formation. (A) The cured film obtained in Example 7 having wiring layers on both surfaces thereof was sandwiched between 2 sheets of the curable film obtained in Example 6 having a conductive copper foil on one surface thereof, and the set of the sandwiched films was subjected to heating and pressurizing by means of a vacuum press to adhere the films to each other. The heating conditions were such that a multistep heating was conducted successively with 120° C./30 minutes, 150° C./30 minutes, and 180° C./100 minutes, and the press pressure of 1.5 MPa. (B) A sheet of a photoresist (HS425 manufactured by Hitachi Chemical Co., Ltd.) was laminated on each of the exterior copper layers on both surfaces of the produced multilayer laminate; test patterns were exposed onto the photoresist and the unexposed portions of the photoresist were developed using a 1% sodium carbonate solution. Thereafter, by use of an etching solution containing sulfuric acid in 5% and hydrogen peroxide in 5%, the uncovered portions of the copper foil was removed by etching, to form conductive wirings on both surfaces. Then the residual photoresist was removed by use of a 3% sodium hydroxide solution, to form the exterior layer wirings. (C) Through holes were formed in the produced multilayer circuit board by the drill machining, and then the board was soaked in a colloidal solution of plating catalyst to provide the plating catalyst to the surface and in the through holes. (D) After the activation treatment of the plating catalyst, an about 1 μm thick seed film was formed by means of the electroless plating (CUST2000 manufactured by Hitachi Chemical Co., Ltd.). (E) A sheet of a photoresist (HN920 manufactured by Hitachi Chemical Co., Ltd.) was laminated on both surfaces of the circuit board. (F) The through hole portions and the end portions of the circuit board were masked and the board was exposed, and thereafter developed with a 3% sodium carbonate solution to arrange an opening portion; then by the electrolytic plating, the through portions were plated with copper in a thickness of about 18 μm. (G) The electrode portions were cut and removed, the residual photoresist was removed by use of a 5% sodium hydroxide aqueous solution; then the circuit board was soaked in the etching solution composed of sulfuric acid in 5% and hydrogen peroxide in 5%, and the etching of an about 1 μm thickness was performed to remove the seed film; thus a multilayer circuit board was produced. Consequently, a multilayer circuit board having 4 conductive wiring layers and excellent in the transmission properties was able to be obtained.

According to the present invention, a resin composition having an extremely low dielectric constant and an extremely low dielectric dissipation factor and excellent in adhesiveness and flexibility can be obtained. Accordingly, a variety of circuit boards and TAB tapes produced by use of the present resin composition come to be circuit boards excellent in high frequency characteristics and high in reliability.

All the publications, patents and patent applications cited herein are incorporated herein by reference in their entirely.

1. A resin composition comprising a crosslinking component having a weight averaged molecular weight of 1,000 or less and multi-functional styrene groups represented by the following general formula: 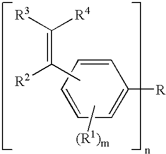
wherein R represents a hydrocarbon moiety; each R¹, which may be the same or different, represents a hydrogen atom or a C₁₋₂₀ hydrocarbon group; R², R³ and R⁴, which may be the same or different, represent a hydrogen atom or a C₁₋₆ alkyl group; and m is an integer of 1 to 4, and n is an integer of 2 or more; and
a rubber component having a weight averaged molecular weight of 5,000 or more and styrene units.

2. The resin composition according to claim 1, wherein the proportion of the carbon atoms and hydrogen atoms is 99% or more in said rubber component.

3. The resin composition according to claim 2, wherein said resin composition further comprises any of polyphenylene oxide, polysulfone, and polyetherimide, and polyolefin having an alicyclic structure, which may have substituents.

4. The resin composition according to claim 2, wherein said resin composition further comprises, as a second crosslinking component, any of phenol resin, epoxy resin, cyanate resin, vinylbenzylether resin, and maleimide resin.

5. A curable film in which organic or inorganic cloth, unwoven cloth or film contains or is applied with a resin composition comprising a crosslinking component having a weight averaged molecular weight of 1,000 or less and multi-functional styrene groups represented by the following general formula: 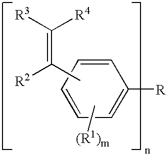
wherein R represents a hydrocarbon moiety; each R¹, which may be the same or different, represents a hydrogen atom or a C₁₋₂₀ hydrocarbon group; R², R³ and R⁴, which may be the same or different, represent a hydrogen atom or a C₁₋₆ alkyl group; and m is an integer of 1 to 4, and n is an integer of 2 or more; and
a rubber component having a weight averaged molecular weight of 5,000 or more and styrene units.

6. The curable film according to claim 5, comprising a conductive layer on at least one surface of the film.

7. A cured film wherein the curable film according to claim 6 is cured.

8. An electronic part comprising, as an insulating layer, a cured product derived from the curable film according to claim 5.
